(19) United States
(12) Patent Application Publication
(10) Pub. No.: US 2016/0267377 A1
(43) Pub. Date: Sep. 15, 2016

(54) Review Sentiment Analysis

(71) Applicant: Staples, Inc., Framingham, MA (US)

(72) Inventors: Jing Pan, Foster City, CA (US); Karthik Kumara, Santa Clara, CA (US)

(21) Appl. No.: 15/068,313

(22) Filed: Mar. 11, 2016

Related U.S. Application Data
(60) Provisional application No. 62/132,154, filed on Mar. 12, 2015.

(51) Int. Cl. G06N 3/04

(52) U.S. Cl. CPC G06N 3/0472

(57) ABSTRACT

Technology for semantically processing user-submitted text and determining probabilities using computer learning model(s) is described. In an embodiment, a method, implemented using a computing device, may include receiving data including user-submitted product review(s) for a product. A product review includes review text and the method determines attributes of the product review text and feed the attributes of the product review text into a first hidden layer of an artificial neural network based on attribute type, feeding the first output of the first hidden layer of the neural network into a second hidden layer of the artificial neural network based on an association of the attributes of the product review with one or more of a story, a function, and a sentiment, and determining a predicted probability of recommendation of the review based on the second output of the second layer.

### CROSS-REFERENCE TO RELATED APPLICATIONS

This application claims the benefit under 35 U.S.C. §119(e) of U.S. Provisional Patent Application No. 62/132,154, entitled “Predicting Product Popularity, Ranking Product Reviews, and Forecasting Product Demand and Stock Levels Based on Review Sentiment Analysis” filed Mar. 12, 2015, which is incorporated herein by reference in its entirety.

### BACKGROUND

The present disclosure relates generally to review sentiment analysis.

Use of web-based applications, such as websites, mobile apps, and various cloud-based services has soared in recent years. Using these applications, users have become accustomed to performing product research and purchasing products online. Often, users defer to reviews made available by an e-commerce site to determine which products are “best”. However, the number of reviews available for a given product can reach into the hundreds or thousands—too many for most potential buyers to manually sift through to make a determination on whether the product is recommended for purchase. This often leads to customer indecision, and ultimately lower overall sales for the e-commerce site. While some online marketplaces by default sort reviews for a product by recency, the number of peer customers (other than the reviewer) that have voted helpfulness, or the average star rating, these sorting mechanisms do not consistently surface the most positive reviews of the product and, as a results, have a lower success rate in converting users to purchase the product.

In some cases, reviewers can indicate in their respective reviews whether they would recommend the product to others. However, this option is sometimes left blank and, as a result, the best endorsements for the product (the reviews that are most likely to recommend a product) are often left hidden or go unnoticed by potential customers.

Traditional ranking of the reviews for a product in some cases is based on a star rating of a given review and a given product. The problem with this approach is that it ignores all the information inside the text of the review itself.

Traditional ranking of the reviews in some cases can also be based on the voted number of helpfulness of a given review and a given product. The problem with is that not every review has people other than the reviewer to vote. The data on the voted helpfulness is so sparse that the product review selected or ranked in this manner is highly skewed. For example, if a product has 100 reviews, 99 of those reviews are not voted and 1 review receives 1 helpful vote. This one review will always be picked as the most helpful review while the rest 99 reviews might be more helpful than this particular one.

Some existing solutions process the text of a review to determine a sentiment score for the review. An example technique for performing sentiment analysis is provided by the Stanford Natural Language Processing Group in the paper by Socher et al., entitled “Recursive Deep Models for Semantic Compositionality Over a Sentiment Treebank”. These solutions use sentiment derived from reviews, social network posts, etc., to provide an assessment of the public's opinion about the product so they can make changes or address concerns.

### SUMMARY

The technology discussed herein addresses the problems with existing solutions discussed in the background section by providing systems, methods, and other aspects to, among other things, determine and rank product reviews according to product purchase recommendation probabilities of those reviews; present product reviews for a product from highly recommended to lowly recommended or vice versa; select a most highly recommended product review for a product; increase purchase probability of a product based on the sentiment-based highlighting (i.e., putting the most highly recommended product review at the top) or ordering of the reviews; interpret emoticons included in a review (which existing solutions ignore) as semantic parsers and sentiment indicators to improve characterization of the sentiment of the review; use predicted probabilities of recommendation of reviews to predict purchase probability and increase profit by offering personalized price offers and marketing content; using predicted probabilities of recommendation to recommend certain products and/or product categories to users; and more reliably forecast stock levels and product demand to improve inventory controls.

By way of example, the technology discussed herein may use purchase probability derived from reviews to personalize pricing offers to customers (the term “customer” is used synonymously as “user” herein) based on stored customer attributes. The personalized pricing model incorporating product-review-based probabilities has the potential to provide millions of dollars in positive revenue lift as compared to conventional pricing models.

In a further example, during the last holiday season, approximately 60% of search results were routinely out of stock on a popular e-commerce website. The innovative technology described herein provides improved inventory planning and stocking tools that reduce out-of-stock incidents during periods of high demand, such as the Christmas holidays, while minimizing excess stock during low-demand periods. This advantageously increases overall profit and/or revenue while minimizing inventory overhead.

The features and advantages described herein are not all-inclusive and many additional features and advantages will be apparent to one or ordinary skill in the art in view of the figures and description. Moreover, it should be noted that the language used in the specification has been selected for readability and instructional purposes and not to limit the scope of the inventive subject matter.

According to one innovative aspect of the subject matter described in this disclosure, a system includes, a computer processor and a non-transitory computer readable medium storing instructions that, when executed by the computer processor, are configured to perform operations including: receiving one or more product reviews for a product, the one or more product reviews having product review text; semantically analyzing the product review text using a first computer model to determine a predicted probability of recommendation for each of the one or more product reviews; selecting a particular product review of the one or more product reviews based on the predicted probability of recommendation of the particular product review; and providing the particular product review for display on a user device.

In general, another innovative aspect of the subject matter described in this disclosure may be embodied in methods that include: receiving a product review for a product, the product review having product review text; determining attributes of the product review text, the attributes including one or more of a word, an emoticon, and punctuation; feeding the attributes of the product review text into a first layer of an artificial neural network based on an attribute type, the first layer of the neural network having a first output; feeding the first output of the first layer of the neural network into a second layer of the artificial neural network based on an association of the attributes of the product review text with one or more of a story, a function, and a sentiment, the second layer having a second output; and determining a predicted probability of recommendation of the review based on the second output of the second layer.

Other implementations of one or more of these aspects include corresponding systems, apparatus, and computer programs, configured to perform the actions of the methods, encoded on computer storage devices.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example computing environment for ranking product reviews, and forecasting product demand and stock levels based on product review sentiment analysis.

FIG. 2 is a block diagram of an example computing system for ranking product reviews, and forecasting product demand and stock levels based on product review sentiment analysis.

FIG. 3A and 3B depict an example embodiment of a neural network.

FIG. 4 depicts example table including data associated with a product having reviews and data available for input into and output by the models discussed herein.

FIG. 5 is an illustration of a graph showing an example relationship between time utility and adjusted time utility.

FIG. 6 is a table including example positions and weights for an example search term.

FIG. 7 is a flowchart illustrating an example method for analyzing the attributes of a product review of a product, ranking the product review, and determining product demand and stock attributes of the product.

FIG. 8 is a flowchart illustrating an example method for determining a product demand and/or a stock level for a product based on the predicted probabilities of recommendation of the reviews for that product.

### DESCRIPTION

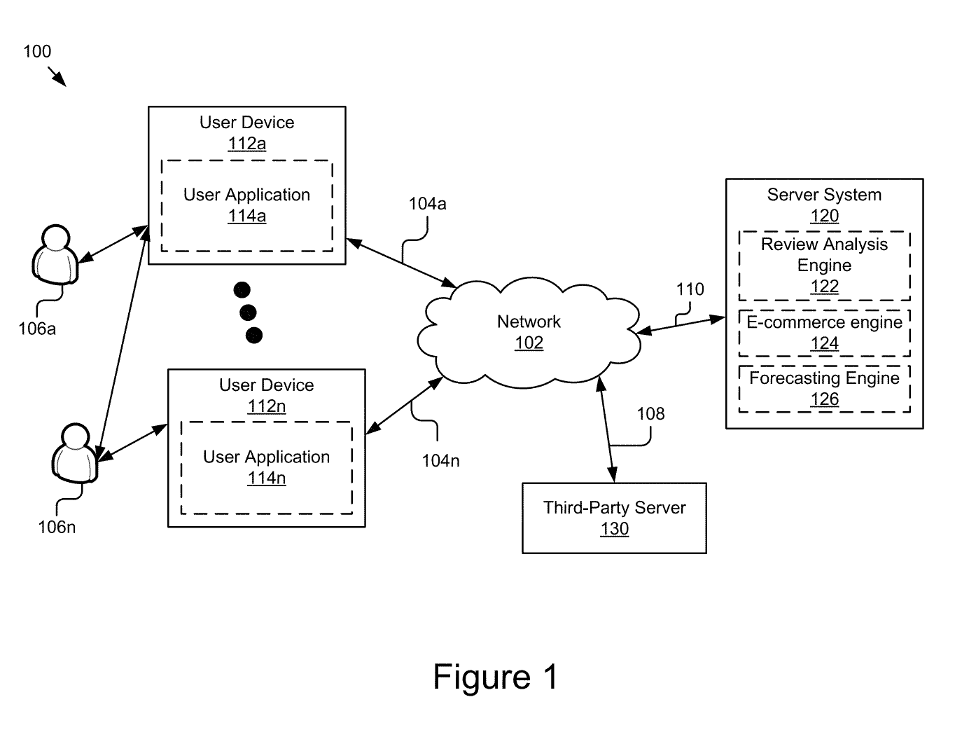

The technology described herein, such as but not limited to the described computing environments, systems, and methods, semantically and/or sentimentally analyzes the content of product reviews and predicts the probability of a product being recommended. Based on the predicted probability of a product being recommended and/or other features, the technology predicts the product purchase probability. Based on the predicted product purchase probability, which reflects product popularity, the technology can, among other things, forecast product demand and stock levels. One example computing environment 100 is depicted in FIG. 1.

The illustrated computing environment 100 may include user devices 112a . . . 112n (also referred to herein individually and/or collectively as 112), a third-party server 130, and a server system 120, which are electronically communicatively coupled via a computer network 102 for interaction with one another, although other configurations are possible including additional or alternative devices, systems, and networks. As shown, the computing environment 100 may include a client-server architecture, although a variety of different system environments and configurations are contemplated and are within the scope of the present disclosure. For instance, various functionality may be moved from a server to a client, or vice versa, data may be consolidated into a single data store or further segmented into additional data stores, and some embodiments may include additional or fewer computing devices, services, and/or networks, and may implement various functionality client or server-side. Further, various entities of the system may be integrated into a single computing device or system or additional computing devices or systems, etc.

The network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, various combinations thereof, etc.

The user devices 112a . . . 112n, and their components, may be coupled to the network 102 via signal lines 104a . . . 104n, respectively. The server system 120 and its components may be coupled to the network 102 via signal line 110 individually or as a whole. The third-party server 130 and its components may be coupled to the network 102 via signal line 108. The users 106a . . . 106n may access one or more of the devices of the computing environment 100. For example, as depicted, user 106a may access the user device 112 in an embodiment, and user 106n may access either/both user devices 112a and 112n (e.g., a smartphone and a laptop).

A user device 112 includes one or more computing devices having data processing and communication capabilities. In some embodiments, a user device 112 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). The user device 112 may couple to and communicate with other user devices 112, the server system 120, the third-party server 130, and the other entities of the computing environment 100 via the network 102 using a wireless and/or wired connection.

Examples of user devices 112 may include, but are not limited to, mobile phones, tablets, laptops, desktops, netbooks, server appliances, servers, virtual machines, TVs, set-top boxes, media streaming devices, portable media players, navigation devices, personal digital assistants, augmented reality glasses, virtual reality goggles, smart watches, other wearable devices, in car or in flight devices, implantable devices, etc. The computing environment 100 may include any number of user devices 112. In addition, the user devices 112 may be the same or different types of computing devices.

As shown in FIG. 1, the user devices 112a . . . 112n may include instances of a user application 114a . . . 114n, which are discussed in further detail below.

The server system 120 and the third-party server 130 may include one or more computing devices having data processing, storing, and communication capabilities. For example, the server system 120 and/or the third-party server 130 may include one or more hardware servers, server arrays, storage devices and/or systems, etc. In some embodiments, the server system 120 and/or the third-party server 130 may include one or more virtual servers, which operate in a host server environment and access the physical hardware of the host server including, for example, a processor, memory, storage, network interfaces, etc., via an abstraction layer (e.g., a virtual machine manager). In some embodiments, the server system 120 and/or the third-party server 130 may include a web server (not shown), a REST (representational state transfer) service, or other server type, having functionality for satisfying content requests and receiving content from one or more computing devices that are coupled to the network 102 (e.g., the user device 112, etc.).

The server system 120 may be specially configured to store, retrieve, analyze, and provide data to enable the semantic processing and analysis of reviews, product purchase prediction, and product and stock forecasts. In a client-server embodiment, the server system 120 may be configured to aggregate, store, and process product data, review data, probability data, and/or the like, and provide product recommendations, personalized offers, sales and product forecasts, and/or the like to various client devices, such as user devices 112a . . . 112n, for consumption by the users of those devices, including customers and administrators, for example.

As depicted in FIG. 1, in some embodiments, the server system 120 may include a review analysis engine 122, an e-commerce engine 124, and a forecasting engine 126, which are discussed in further detail below. However, it should be understood that other configurations are possible and contemplated. For example, some or all of the components 114, 122, 124, and/or 126 and/or functionality or acts thereof, may be combined or segmented into further components. Additionally, the components, or some or all of their functionality and/or acts, may be integrated into other software or hardware without departing from the scope of this disclosure.

The third-party server 130 may include software and/or hardware logic executable by it to provide various services such as data aggregation services configured to collect and provide data about users as they visit various websites, online shopping portals, website analytics, federated identity authentication services, other hosting, social networking, news, or content services, a combination of one or more of the foregoing services; or any other service where users store, retrieve, collaborate, and/or share information, purchase products, transact business, etc.

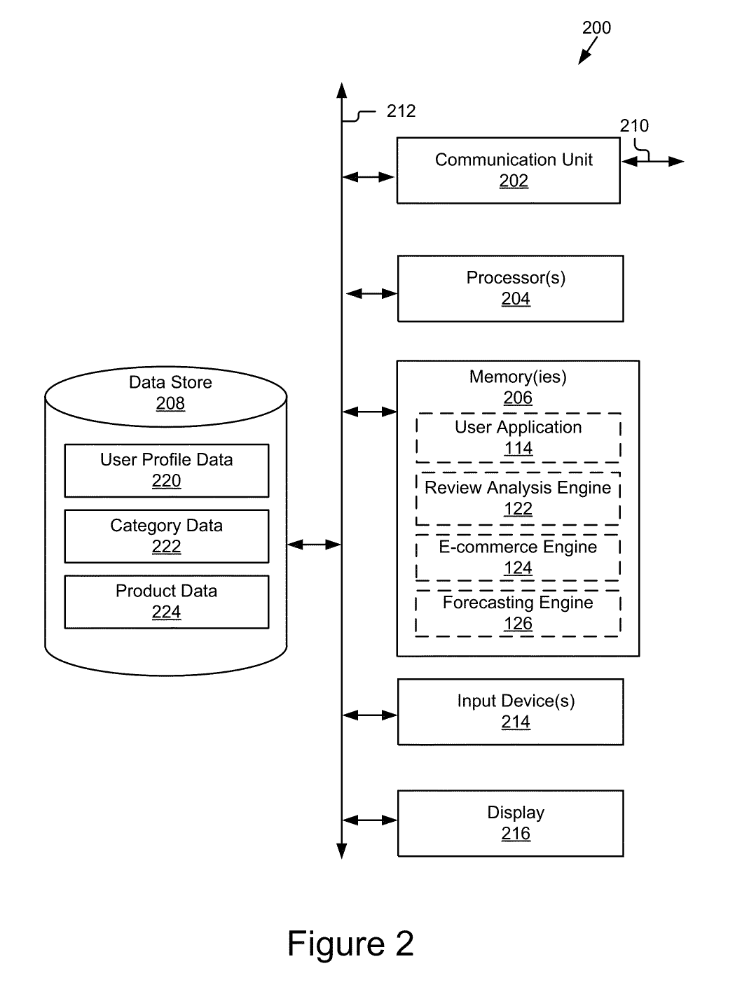

FIG. 2 is a block diagram of an example computing system 200, which may in general represent the computer architecture of a user device 112, a server system 120, and/or a third-party server 130, although various components may be excluded or not represented, depending on which entity is being represented.

As depicted, the computing system 200 may include a processor(s) 204, a memory(ies) 206, a communication unit 202, a data store 208, input device(s) 214, and a display 216, which may be communicatively coupled by a communication bus 212. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations.

The processor(s) 204 may execute software instructions by performing various input, logical, and/or mathematical operations. The processor(s) 204 may have various computing architectures to process data signals, may be physical and/or virtual, and may include a single core or plurality of processing units and/or cores. In some embodiments, the processor(s) 204 may be capable of generating and providing electronic display signals to a display device, supporting the display of images, capturing and transmitting images, performing complex tasks including various types of feature extraction and sampling, etc. In some embodiments, the processor(s) 204 may be coupled to the memory(ies) 206 via the bus 212 to access data and instructions therefrom and store data therein. The bus 212 may couple the processor(s) 204 to the other components of the server system 120 including, for example, the memory(ies) 206, the communication unit 202, the input device(s) 214, the display 216, and the data store 208.

The memory(ies) 206 may store and provide access to data to the other components of the computing system 200. In some embodiments, the memory(ies) 206 may store instructions and/or data that may be executed by the processor(s) 204. For example, as depicted in FIG. 2, the memory(ies) 206 may, depending on the configuration, store the user application 114, the review analysis engine 122, the e-commerce engine 124, and/or the forecasting engine 125. The memory(ies) 206 are also capable of storing other instructions and data, including, for example, an operating system, hardware drivers, other software applications, databases, etc. The memory(ies) 206 may be coupled to the bus 212 for communication with the processor(s) 204 and the other components of computing system 200.

The memory(ies) 206 include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor(s) 204. In some embodiments, the memory(ies) 206 may include one or more of volatile memory and non-volatile memory. Non-limiting examples include a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory(ies) 206 may be a single device or may include multiple types of devices and configurations.

The bus 212 can include a communication bus for transferring data between components of a computing device or between computing devices, a network bus system including the network 102 or portions thereof, a processor mesh, a combination thereof, etc. In some embodiments, the review analysis engine 122, the e-commerce engine 124, and/or the forecasting engine 125, and various other components operating on the server system 120 (operating systems, device drivers, etc.) may cooperate and communicate via a communication mechanism included in or implemented in association with the bus 212. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 202 may include one or more interface devices (I/F) for wired and wireless connectivity with the network 102 and the other components of the computing environment 100, for example, the user device 112, the server system 120, the third-party server 130, etc. For instance, the communication unit 202 may include, but is not limited to, CAT-type interfaces; wireless transceivers for sending and receiving signals using Wi-Fi™; Bluetooth®, IrDA™, Z-Wave™, ZigBee®, cellular communications, etc.; USB interfaces; various combinations thereof; etc. The communication unit 202 may include radio transceivers (e.g., 5G+, 4G, 3G, 2G, etc.) for communication with the network 102, and radio transceivers for Wi-Fi™ and close-proximity/personal area (e.g., Bluetooth®, NFC, etc.) connectivity, geo-location transceivers (e.g., GPS) for receiving and providing location information for the corresponding device, and the like. The communication unit 202 may be coupled to the other components of the computing system 200 via the bus 212. The communication unit 202 may be coupled to the network 102 as illustrated by the signal line 210. In some embodiments, the communication unit 202 can link the processor(s) 204 to the network 102, which may in turn be coupled to other processing systems. The communication unit 202 can provide other connections to the network 102 and to other entities of the computing environment 100 using various standard communication protocols, including, for example, those discussed elsewhere herein.

The data store 208 is an information source for storing and providing access to data. The data stored by the data store 208 may be organized and queried using various criteria including any type of data stored by them, such as a user/customer identifier, rewards account number, product identifier, product name, product category, tags, locations, merchant, user device, electronic address, where products were purchased from, sequence of products bought by an account, etc. The data store 208 may include data tables, relational/semi-structured/graph/etc., databases, or other organized or unorganized collections of data. Examples of the types of data stored by the data store 208 may include, but are not limited to, user profile data 220, category data 222, product data 224, PPRs, learning data, pricing data, web analytics, various data and/or computer models, output data from models discussed herein, etc., as discussed elsewhere herein. The review analysis engine 122, the e-commerce engine 124, and the forecasting engine 126 may be coupled to retrieve, generate, and/or store any applicable data in the data store 208 in order to carry out their respective acts and functionalities.

The user application 114 may generate and submit data requests to the server system 120 for data, such as product-related data for browsing products, review-related data for researching products, product purchase data for purchasing products, etc., and the e-commerce engine 122 or other suitable component of the server system 120 (e.g., such as a dedicated API) may receive and process the requests, retrieve, generate and/or process data to fulfill those requests (e.g., in cooperation with the other components 122 and/or 126 at times, as discussed herein), and generate and send appropriate responses including the requested data.

The data store 208 may be included in the computing system 200 or in another computing system and/or storage system distinct from but coupled to or accessible by the computing system 200. The data store 208 can include one or more non-transitory computer-readable mediums for storing the data. In some embodiments, the data store 208 may be incorporated with the memory(ies) 206 or may be distinct therefrom. In some embodiments, the data store 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, i.e., insert, query, update and/or delete, rows of data using programmatic operations. In these or other instances, the DBMS may store data as nodes and edges of graph, key-value pairs, or documents.

The user profile data 220 describes the users of the computing environment 100. The user profile data 220 includes the user accounts of the users and stores attributes describing the users. Non-limiting examples of user attributes include an e-mail address, IP address, demographics data, user id, rewards account number, product identifier, etc. In some embodiments, the user profile data 220 includes information learned from user behavior (e.g., interaction data) through various computer-learning methods, as discussed elsewhere herein. In some embodiments, the user profile data 220 includes information provided by a user, such as a username, password, preference data, payment information, etc.

The user profile data 220 may include interaction data tracking current and past interactions with the server system 120 and, in some embodiments, other servers (e.g., a third-party server 130). The interaction data includes history data, which is an aggregation of past behavior of the user. Non-limiting examples of past user behavior include webpages the user 106 has visited, items (e.g., pages, elements on a page, etc.) the user 106 has interacted with (e.g., typed, clicked, hovered over, etc.), Internet searches the user 106 has made, etc.

The category data 222 includes a set of product categories. Each category may include a plurality of products. The products included in the categories may be linked with the products in the product data 224. Each category may be characterized using one or more tags.

The product data 224 includes a plurality of product records respectively describing products available via the e-commerce engine 124. Users may interact with customized interfaces presented by the computing environment 100 to browse and/or purchase products. Each product record may describe the various aspects of the products. Each record may include one or more product tags characterizing the product. Each record may also include unique product identifiers, names, descriptions, manufacturer info, specifications, photos, videos, reviews, predicted probabilities of recommendations of reviews, ratings, etc. for products.

The input device(s) 214 may include any device for inputting information into the computing system 200. In some embodiments, the input device(s) 214 may include one or more peripheral devices. For example, the input device(s) 214 may include a keyboard (e.g., a QWERTY keyboard), a pointing device (e.g., a mouse, joystick, or touchpad), microphone, an image/video capture device (e.g., camera), a physiology measuring device (e.g., electroencephalogram device, eye-tracker, or heart rate monitor), etc. In some embodiments, the input devices 214 may include a touch-screen display capable of receiving input from the one or more fingers of the user. For instance, the structure and/or functionality of one or more of the input device(s) 214 and the display 216 may be integrated, and a user of the computing system 200 may interact with the computing system 200 by contacting a surface of the display 216 using one or more fingers. In this example, the user could interact with an emulated (i.e., virtual or soft) keyboard displayed on the touch-screen display 216 by using fingers to contact the display in the keyboard regions.

The display 216 may display electronic images and data output by the computing system 200 for presentation to a user 106. The display 216 may include any conventional display device, monitor or screen, including, for example, an organic light-emitting diode (OLED) display, a liquid crystal display (LCD), etc. In some embodiments, the display 216 may be a touch-screen display capable of receiving input from one or more fingers of a user 106. For example, the display 216 may be a capacitive touch-screen display capable of detecting and interpreting multiple points of contact with the display surface. In some embodiments, the computing system 200 may include a graphics adapter (not shown) for rendering and outputting the images and data for presentation on display 216. The graphics adapter (not shown) may be a separate processing device including a separate processor and memory (not shown) or may be integrated with the processor(s) 204 and memory(ies) 206.

As depicted in FIGS. 1 and 2, a computing system 200 embodying a server system 120 may include a review analysis engine 122, an e-commerce engine 124, and a forecasting engine 126. These components 122, 124, and 126 may be communicatively coupled by the bus 212 and/or the processor(s) 204 to one another and/or the other components 202, 204, and 208 of the computing system 200. In some embodiments, one or more of the components 122, 124, and 126 may include computer logic executable by the processor(s) 204 to provide their acts and/or functionality. In any of the foregoing embodiments, these components 122, 124, and 126 may be adapted for cooperation and communication with the processor(s) 204 and other components of the computing system 200.

The review analysis engine 122 may be implemented using software and/or hardware logic that is executable by a computing system, such as the server system 120, to analyze product reviews and determine recommendation probability for each review. An example method for semantically analyzing a product review includes feeding the text of the product review into a computer model that is configured to output a predicted probability of recommendation (PPR) for a product reviewed by the product review (reflecting the probability of a product being recommended by the product review), although other suitable methods are also possible and contemplated.

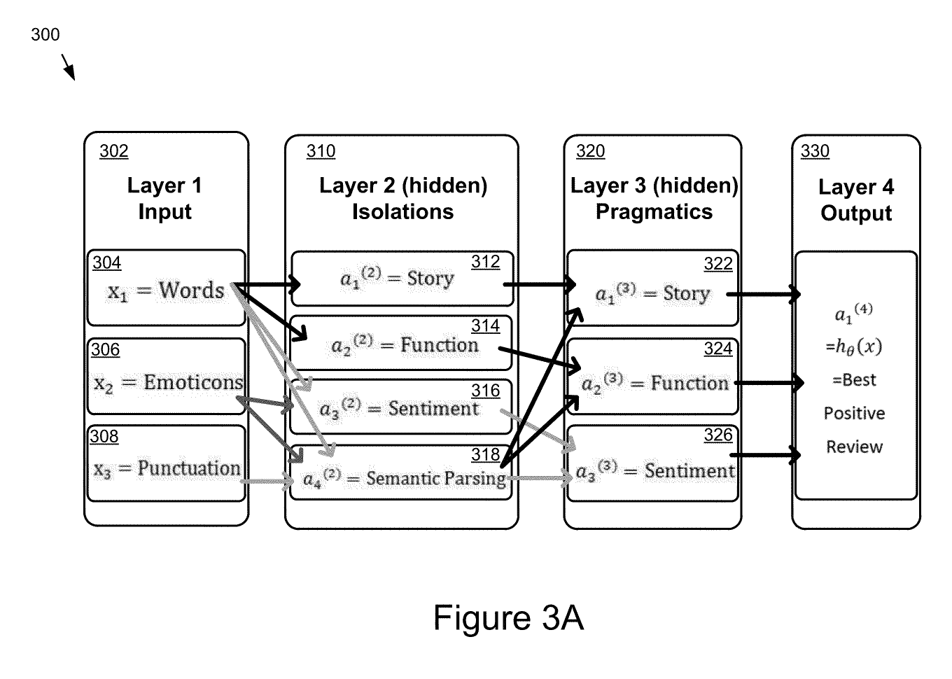

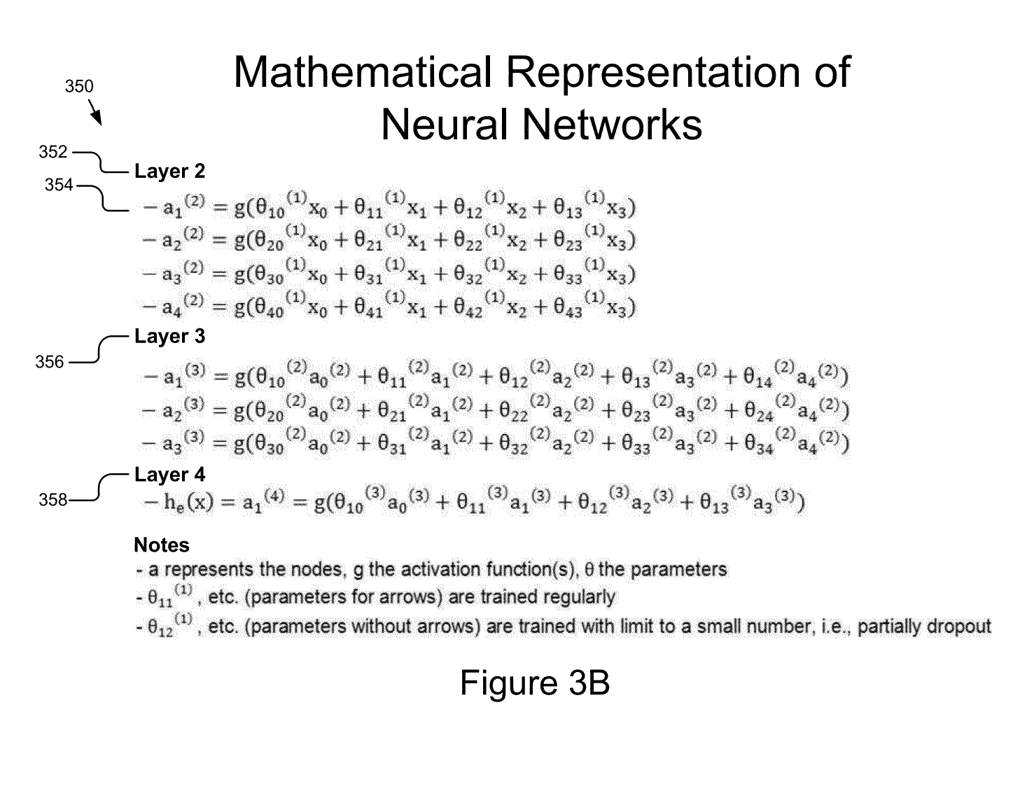

The computer model may include any suitable machine learning algorithm capable of being trained and representing probabilities between variables (e.g., quantities, latent variables, parameters, etc.). Example models may include Bayesian networks, decision trees, Hidden Markov Models, other neural networks, etc. (e.g., FIG. 3A and 3B depict an example embodiment of a neural network, according to the techniques described herein). The text of a given product review is fed into the computer model and the model outputs the PPR for that review in review analysis engine 122. The PPR for each review may be used to predict the product's popularity and/or rank the reviews for the product, as discussed elsewhere herein.

The e-commerce engine 124 may be implemented using software and/or hardware logic that is executable by a computing system, such as the server system 120, to enable an e-commerce marketplace for products and may store and provide access to product information (e.g., reviews, images, descriptions, categories, specifications, ratings, retailers, etc.) in a data store, such as the data store 208 (e.g., see FIG. 2). The e-commerce engine 124 may receive requests to purchase products, and may place and provide for order fulfillment for the products (e.g., print products, office products, consumer products, online services, home or business services, etc.) including order delivery status and item returns. In an example, a user 106 may place orders for and/or pay for products ordered on an e-commerce marketplace using a user device 112.

The e-commerce engine 124 is operable to provide an e-commerce service/marketplace for various products and may store and provide access to product information (e.g., images, descriptions, categories, specifications, reviews, ratings, retailers, etc.) in a data store, such as the data store 208 (e.g., see FIG. 2). For example, the e-commerce engine 124 may serve a content (e.g., webpages, structured data, etc.) page customized at least in part by the content customization engine 122, and requested by the user devices 112, as discussed in further detail elsewhere herein.

The e-commerce engine 124 may receive requests for product information about certain products and, responsive to those request, may generate the product information including reviews based on the PPRs associated with those reviews. For instance, when retrieving product information for a particular product, the e-commerce engine 124 may retrieve the PPRs computed by the review analysis engine 122 for the reviews associated with that product and may filter and/or rank the reviews. In an example, the e-commerce engine 124 may select a review to feature in the product information based on that review having the best (e.g., highest) PPR relative to the other review PPRs for that product. In another example, the e-commerce engine 124 may order the reviews from best PPR to worst PPR, thereby reinforcing the positive reviews for the product. In both cases, providing product results and/or information featuring and/or presenting the review or reviews with the best PPRs to the user via his/her client device can increase the probability of a purchase of the product by the customer. Moreover, when applied consistently across the virtual marketplace, overall sales also increase, leading to significantly higher profits and revenues.

Further, it is often the case that reviewers fail to input whether they would recommend that others purchase the product (e.g., a binary indicator, such as Yes or No). The e-commerce engine 124 overcomes this problem by using the output of the review analysis engine 122 to determine, without the reviewer's binary indicator, whether a review is positive, neutral, or negative, or in other words, would recommend purchase of the product, neither recommends or opposes the purchase of the product, or opposes the purchase of the product. Thus, as a practical effect, the e-commerce engine 124 can make a relatively balanced, objective determination on how to rank and select product reviews for viewing by customers.

The e-commerce engine 124 may provide product information responsive to receiving a search query for a specific product, products matching a keyword, a product category, or any other suitable request criteria. In further examples, the product information may be unsolicited by users and instead requested by an internal component, such as an event trigger, marketing campaign, or other signal. The event trigger may reflect a weekly marketing email sent to registered users. The e-commerce engine 124 may dynamically determine which products to market to those users based on user preferences, which may be derived from historical information stored and accessible from the data store 208 about the user (e.g., stored user preferences, past purchases, browsing history, third-party data aggregators (providing information about current browsing behavior and/or interests of the user), and/or the like. The e-commerce engine 124 may select products based the user preferences and include one or more product reviews selected and/or ranked based on their PPRs, as discussed elsewhere herein, and generate and send electronic messages such as marketing emails including the product information to the customers for consumption.

The e-commerce engine 124 may format the information it generates and/or provides using any suitable format. For instance, the e-commerce engine 124 may format the product information as a HTML, XML, JSON, JavaScript, other structured or semi-structured data, etc.), as discussed in further detail elsewhere herein.

The user application 114 includes software executable by a user device 112 to provide users 106 with a portal for researching, browsing, and purchasing products. In some embodiments, the portal may be a consumer-facing or a business-to-business product marketplace. Users 106 may browse and search for products using the portal page elements, or may be referred to particular page of the portal from external sites, such as other applications (e.g., websites, native applications, etc.). In some cases, a user may be referred to particular page, such as a search result page, a product category page, or particular product page, responsive to entering a search query including certain keyword(s) or phrase(s) describing products or product categories of interest, or selecting product or product category links included on other pages. In further embodiments, users 106 may receive personalized electronic messages including descriptive product information, such as information featured products, personalized products selections matching the user, popular products, etc. The product information may include links to the corresponding pages in the portal for purchasing and/or further browsing the products. Other variations are also possible.

The forecasting engine 126 may be implemented using software and/or hardware logic that is executable by a computing system, such as the server system 120, to predict purchase probability, forecast product demand, and forecast inventory levels including the point of time when the product will be sold out/out of stock. The predictions and forecasting are based on the review semantics processing output of the review analysis engine 122.

The forecasting engine 126 may predict the purchase probability of a given product based on the user attributes, product attributes, and review PPRs associated with that product. For example, the forecasting engine 126 may aggregate the PPRs across a segment of reviews (all, most recent, a number up to a threshold, etc.) to determine an aggregate PPR reflecting an overall recommendation probability for that product. In an example, the aggregate PPR may reflect a likelihood (e.g., on a scale of 0-100%) that the reviews collectively recommend purchase of the product.

In a further example, the forecasting engine 126 may include a gradient-boosted machine (GBM) configured to output the probability that a given product will be purchased during a particular browsing session associated with a particular user. In some embodiments, the GBM may accept/receive as input 1) the PPR(s) for the reviews of that product as input; 2) an average PPR for the reviews of that product; or 3) a time-diminished average PPR for the reviews of that product, as computed by the review analysis engine 122. The GBM may use this input, in conjunction with other input variables, such as click-stream classification data (classifying the user's clickstream as a purchase clickstream or a non-purchase clickstream) and/or product review tags to estimate the probability that the user will purchase the product during that session.

The forecasting engine 126 may use the PPRs and/or aggregated PPR in conjunction with the user attributes reflecting the users' habits in purchasing products and the product attributes reflecting product popularity and/or historical sales (by day, week, season, etc.) to generate a purchase probability for the product for a given time frame (e.g., that day, the next day, that week, that month, that year, etc.). In addition, as review positivity and/or momentum builds for a given product, the PPRs and/or aggregate PPR will likely also increase over time, and the forecasting engine 126 may consider the momentum of the increase(s) in determining purchase probability.

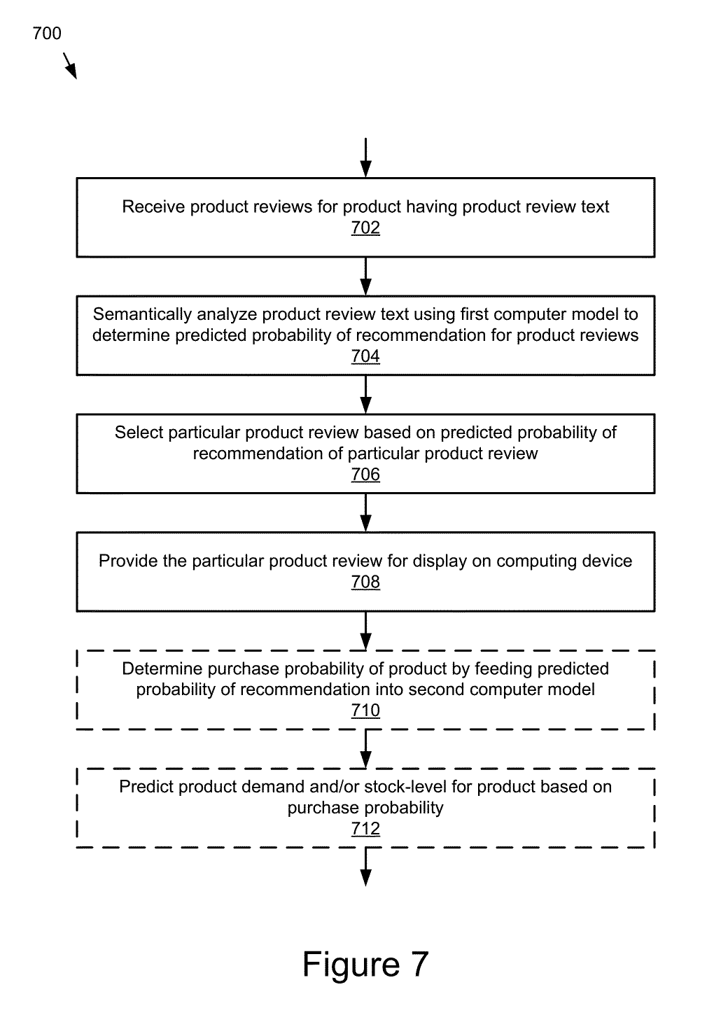

FIG. 7 is a flowchart illustrating an example method 700 for analyzing the attributes of product review(s) of product(s), ranking the product review(s), and determining product demand and stock attributes of the product(s). At 702, the review analysis engine 122 receives product reviews for a product. A product review may include product review attributes, such as, descriptive text, emoticons, and punctuation, etc. At 704, the review analysis engine 122 semantically analyzes product review attributes (e.g., text) using a first computer model to determine a PPR for each of the product reviews.

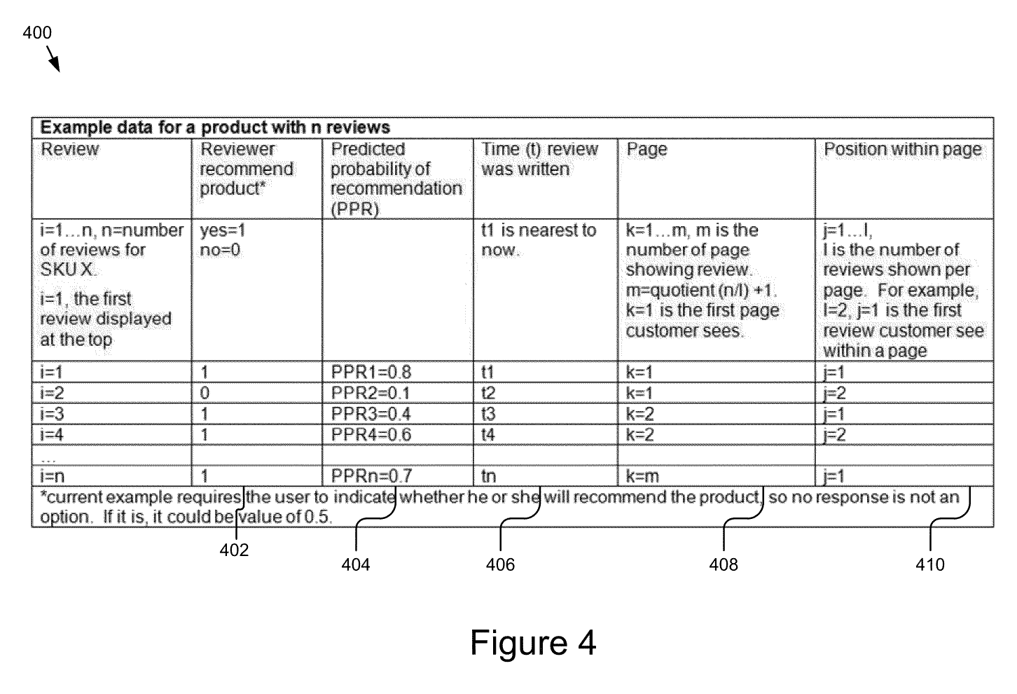

An example embodiment of analyzing product review text is described in reference to FIGS. 3A and 3B. In particular, FIGS. 3A and 3B depict an example neural network layer framework 300 for semantically processing each product review attribute. The neural network is configured to predict a corresponding PPR. In this example, the dependent variable may reflect whether the reviewer will recommend the product as shown in column “Reviewer recommend product” 402 or PPR 404 in FIG. 4. As shown in block 302, the characters embodying the review are features or attributes, and are parsed according to feature/attribute type. For instance, the words of the review are parsed and input into the model in block 304, the emoticons of the review are parsed and input into the model in block 306, and the punctuation marks are parsed and input in to the model in block 308.

(e.g., a neural network framework of SparX to predict a best positive review)

In block 310, the various dimensions of the review are isolated. For instance, the words of the story are isolated in block 312, the function of each of the words of the story is isolated in block 314, the sentiment of each of the words and emoticons of the review is isolated in block 316, and the semantics of the words and the emoticons are isolated in block 318. Uniquely, in block 318, the emoticons are interpreted not only as reflective of an emotion conveyed by an author of a review, but also as a punctuation mark that signifies the end of a thought or sentence.

In block 320, the story, function, and sentiment of the review are determined in blocks 322, 324, and 326, respectively. In block 322, the words isolated in block 312 are interpreted in conjunction with the semantics isolated in block 318 to determine the narrative of the review. In block 324, the functions of the words are interpreted in conjunction with the semantics parsed in block 318 to the function of the sentences making up the review. In block 326, the sentiment of the emoticons are interpreted in conjunction with the semantics parsed in block 318 to determine the sentiment of the sentences making up the review. The output of block 320 is then used in block 330 to determine and output a dependent variable reflecting the PPR of that review, for example, the output may include a PPR, a best positive review, a most useful review, etc.

Advantageously, the PPR output by the model 300 for a given review of a particular product can be used to determine which review from among all reviews of a product is the best positive review (e.g., with the highest PPR) of that product. This allows the e-commerce engine 124 to directly rank the review using the PPR and select the review that it has the best PPR relative to other reviews for that product, as discussed in further detail below.

FIG. 3B illustrates an example mathematical representation 350 of a neural network according to some embodiments. The mathematical representation 350 may correspond to the example neural network described in reference to FIG. 3A. For example, the mathematical representation 350 includes layers and relations corresponding to the layers and nodes of FIG. 3A. For example, the mathematical representation 350 includes a second layer 352 corresponding to the second layer 310 in FIG. 3A. Additionally, the mathematical representation 350 includes a relation 354 corresponding to the node at 312 in FIG. 3A. The relation 354 includes a function with inputs corresponding to attributes and parameters (represented by theta). The parameters may be trained (e.g., according to supervised or unsupervised training, etc.). Similarly, FIG. 3B includes layers 3 and 4, at 356 and 358 respectively, with corresponding relations matching the layers and nodes of FIG. 3A.

Returning to FIG. 7, at 706, the e-commerce engine 124 may use the PPR computed by the review analysis engine 122 to select a particular product review based on the PPR of the particular product review and, at 708, the e-commerce engine 124 may provide the particular product review for display on a computing device, such as in an interface generated and displayed by a user application 114 of a user device 112. In some instances, the e-commerce engine 124 and/or user application 114 may order product reviews according to the PPR of each review. For example, according to the analysis described herein, the e-commerce engine 124 and/or the user application 114 may select one or more best positive reviews to place in a easily viewable area of a webpage (e.g., at the top, at the top of a list of reviews, etc.). This is a particularly beneficial aspect of the techniques described herein because it allows a metric of usefulness of a product review to differentiate among hundreds, thousands, etc., of product reviews for a product. As described elsewhere herein, the scroll or click through rate (e.g., of the scenarios of webpages) decreases substantially for customers of an online market place, as such it is beneficial to determine the most viewed areas of a display of product reviews and locate the most useful product reviews in those graphical display areas.

In some embodiments, the e-commerce engine 124 may additionally or alternatively order product reviews according to another metric than PPR, such as a time diminished PPR, as is described below.

At 710, the forecasting engine 126 may determine a purchase probability of the product by feeding the PPR into a second computer model along, in some cases, with other attributes to determine a purchase probability for a product associated with the product reviews and/or a product demand. In some embodiments, the second computer model may include a GBM or time series model. For example, the forecasting engine 126 may feed the PPR and, in some instances, one or more of the attributes described below into the second computer model to determine a purchase probability. For instance, a combination of a user attribute that a user has a certain likelihood of purchasing a product with a PPR above a certain threshold along with the PPR (or variation thereof, described below) can be input into the second computer model to find the purchase probability for that product for that user. It should be understood that many alternatives for calculating the purchase probability for a product exist and are contemplated in the techniques described herein.

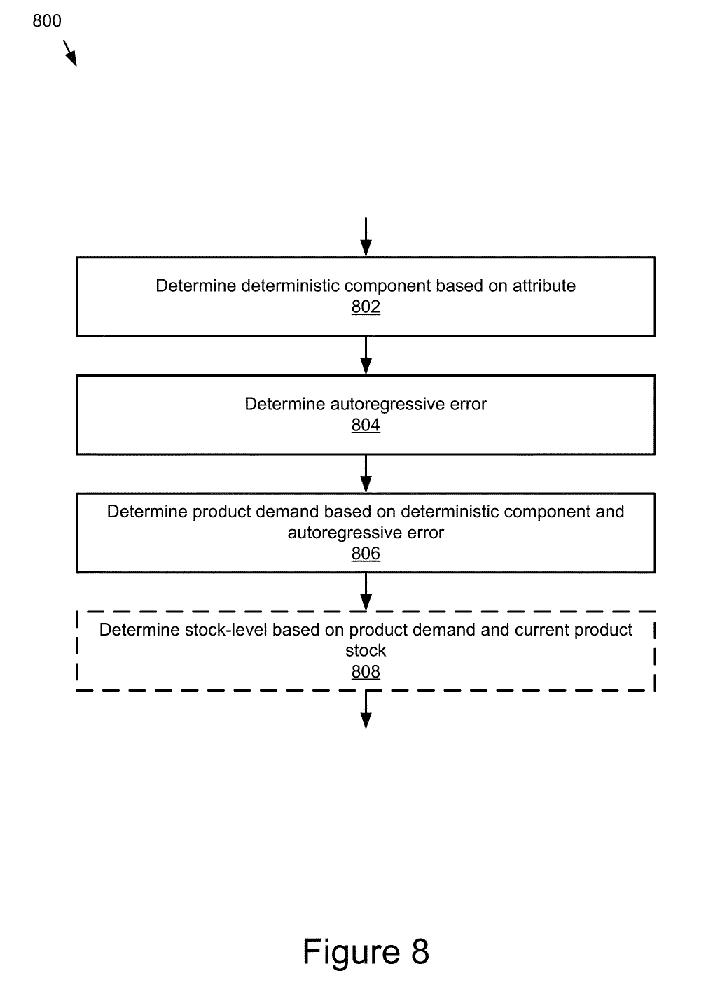

At 712, the forecasting engine 126 may predict product demand and/or stock level for a product based on the purchase probability and/or PPR. An example method of predicting product demand and/or stock level is described in further detail in reference to FIG. 8.

FIG. 4 depicts example table 400 including data associated with a product X having n reviews, such as data available for input into and output by the models discussed herein. In some instances, the table 400 may include a column 402 representing whether the product was recommended by a reviewer. As shown at column 404, the model 300 outputs a PPR for each review of a particular product. Timing, page, and position information are also included at columns 406, 408, and 410, respectively, which may be used by the e-commerce engine 124 to predict product popularity and/or select and/or rank reviews for a product, and may be used by the forecasting engine 126 to forecast product demand and predict stock levels (e.g., whether and when a product may go out-of-stock), as discussed below and in association with the forecasting engine 126. Also, as discussed further below, the output of model 300 (e.g., PPR(s)) may be fed into a downstream time series model of the forecasting engine 126 as feature(s) (e.g., independent variable(s)), along with other features and used by this time series model to forecast product demand (e.g., as discussed in further detail in reference to FIG. 8). The forecasting engine 126 may use the output of this model (e.g., the predicted product demand) to predict the stock levels for that product (e.g., when the product will go out-of-stock).

Two specific examples of scenarios for presenting product reviews for a particular product via the user application 114 are described herein, but it should be understood that other formats and configurations presenting product reviews are also possible, contemplated, and encompassed by this disclosure. In the first scenario, also called scenario 1, the reviews are presented as an infinitely scrollable multidimensional matrix, which the user can scroll through using the user application 114 (e.g., by scrolling down on the scroll view). In the second scenario, also called scenario 2, the reviews are presented on multiple pages progressing from first page which includes the highest ranked reviews to the last page which includes the lowest ranked reviews, and the user navigates through the various pages of reviews using pagination. In scenario 2, the ranking of the reviews can be determined by but not limited to the PRR, recency, star ratings, upvotes, a combination of the foregoing and/or, other factors, etc.

The aggregation of PPRs of a product, which are used to compute the weighted average of PPR, by the forecast engine 126, are now described. FIG. 4 illustrates one product with SKU X that has n reviews. In scenario 1, the forecasting engine 126 may compute the utility data using timing information associated with the review. In a non-limiting example, the forecast engine 126 may use the following equation (1) for computing the time utility of review i:

$$Time {Utility}_{i} = \frac{( {timestamp}_{now} - {timestamp}_{origin} )}{( {timestamp}_{now} - {timestamp}_{{t}_{i}} ) - 1} \qquad ( 1 )$$

In equation (1), the timestamp convention may be any conventional system timestamp, such as a POSIX timestamp, a 1900 date system timestamp, and/or the like; timestamp_{now} is the timestamp reflecting the current point in time (e.g., when the model is built or trained); origin is timestamp_{origin} is the timestamp reflecting an initial reference point, such as the origin of the review system (for example, when the e-commerce marketplace first adopted an online review system); and the minus 1 ensures that the utility is zero if the review i was created at the beginning of the time.

For a particular product SKU, e.g., SKU X, with i=1,2, 3 . . . n reviews, the weighted average of predicted probability of recommendation may be given by the following equation (2):

$$Weighted Average of PPR of SKU X = \frac{{\sum }_{i = 1}^{n} ( {time\_utility}_{i} * {PPR}_{i} )}{{\sum }_{i = 1}^{n} {time\_utility}_{i}} \qquad ( 2 )$$

In some further embodiments, the review analysis engine 122 may compute a weighted average for the PPRs based on an exponential decay. First, the difference between timestamp_{now} and the timestamp of the review i is computed using the following equation (3):

time_deltaᵢ=timestamp_{now}−timestampₜ_{ᵢ} (3)

Next, a weight for the difference in time is computed using the following equation (4):

time_weightᵢ=e^{γ+time}^{_}^{delta}^{ᵢ} (4)

In equation (4), γ is a constant determined by empirical data or tuned to minimize error in the time series models for predicting product purchase probability.

Then, the weighted average is computed using the following equation (5):

$$Weighted Average of PPR of SKU X = \frac{{\sum }_{i = 1}^{n} ( {time\_weight}_{i} * {PPR}_{i} )}{{\sum }_{i = 1}^{n} {time\_weight}_{i}} \qquad ( 5 )$$

In Scenario 2, where the system 200 is configured to present (e.g., display) reviews over multiple pages on the user application 114, the forecasting engine 126 may perform a utility based weighting of PPRs, which allows the forecasting engine 126 to account for the often dramatic decline in click-through rate (e.g., from infinity to zero) that occurs for reviews the farther they are in time and/or digital proximity from the most prominent (e.g., top) of the first page of review(s), as well as the often dramatic decline in the click-through rate of reviews the lower they are on the page relative to other reviews (based on evidence gathered from eye tracking research).

In an embodiment, page utility can be computed by the forecasting engine 126 using equation (1) and the following equation (6) for computing page utility:

$${page\_utility}_{k} = \frac{m}{k - 1} \qquad ( 6 )$$

Average time utility within a page k, can be computed using the following equation (7) or (8) depending on the value of k. For k<m equation (7) may be used and for k<=m, equation (8) may be used.

$$\begin{matrix}average\_time {\_utility}_{k , k < m} = \frac{{\sum }_{i = l * ( k - 1 ) + 1}^{i = l * k} {time\_utility}_{i}}{l} & ( 7 ) \\ \begin{matrix}average\_time {\_utility}_{k , k = m} = \frac{{\sum }_{i = l * ( k - 1 ) + 1}^{i = m} {time\_utility}_{i}}{m - l * ( k - 1 )} \\ = \frac{{\sum }_{i = l * ( m - 1 ) + 1}^{i = m} {time\_utility}_{i}}{m - l * ( m - 1 )}\end{matrix} & ( 8 )\end{matrix}$$

The forecasting engine 126 may then use the page utility and the average time utility for the page k to compute an adjusted average time utility of page k (which reflects the often dramatic discount in time utility), as shown in equation (9).

$$adjusted\_average \_time {\_utility}_{k} = \frac{{page\_utility}_{k} * average\_time {\_utility}_{k}}{{page\_utility}_{k = 1}} \qquad ( 9 )$$

In equation (9), if the click through rate from page 1 to page k is known,

$$\frac{{page\_utility}_{k}}{{page\_utility}_{k = 1}}$$

then replace then can be substituted with the click through rate.

The forecasting engine 126 can calculate the position disposition of page j, which just precedes page k, for instance, using the following equation (10).

$${position\_disposition}_{j} = cosine ( π * \frac{j}{l} ) \qquad ( 10 )$$

This disposition can be used to determine a time utility residual value for the various different review presentation scenarios, such as Scenario 1 and 2. In particular, in Scenario 1, as the click through rate from page 1 to page k is unknown, the time_utility_residual can be computed using, for example, the following equation (11) when

$$j \leq \frac{l}{2}$$

and the following equation (12) when

$$j > \frac{l}{2} \text{:}$$

$$\begin{matrix}time\_utility {\_residual}_{ijk , j \leq \frac{l}{2}} = \frac{{page\_utility}_{k} * ( {time\_utility}_{i = l * ( k - 1 ) + 1} - average\_time {\_utility}_{k} )}{{page\_utility}_{k = 1}} * \frac{{position\_disposition}_{j}}{{page\_utility}_{k = 1}} & ( 11 ) \\ time\_utility {\_residual}_{ijk , j > \frac{l}{2}} = \frac{{page\_utility}_{k} * ( average\_time {\_utility}_{k} - {time\_utility}_{i = l * k} )}{{page\_utility}_{k = 1}} * \frac{{position\_disposition}_{j}}{{page\_utility}_{k = 1}} & ( 12 )\end{matrix}$$

In the above equations, if the click through rate from page 1 to page k is known, such as in Scenario 2,

$$\frac{{page\_utility}_{k}}{{page\_utility}_{k = 1}}$$

can be substituted with the accumulated click through rate.

In scenarios where the user navigates to the earlier pages or later pages by persistently clicking a “previous” or “next” link until the desired page shows up, the accumulated click through rate of that progressions can be computed using the following equation (13):

$$accumulated\_click \_through \_rate {( CTR )}_{1 \_to \_k} = {\prod }_{a = 1}^{k - 1} click\_through {\_rate}_{a\_to \_a + 1} \qquad ( 13 )$$

In equation (13), a is an iterator from 1 to k−1.

In further scenarios, the preceding or subsequent review pages of reviews may be represented on each page (or at least up to a certain number of preceding or subsequent pages), in which case the accumulated_CTR₁_{_}ₜₒ_{_{—k}} may be a product of the click through rates of whichever pages/steps were used to arrive at the page k.

In some embodiments, the following equations (14), (15), and (16) may be used by the forecasting engine 126 to compute the time utility residuals for scenarios in which the accumulated_CTR₁_{_}ₜₒ_{_{—k}} is relevant.

$$\begin{matrix}time\_utility {\_residual}_{ijk , j \leq \frac{l}{2}} = {accumulated\_CTR}_{1 \_ to \_k} * ( {time\_utility}_{i = l * ( k - 1 ) + 1} - average\_time {\_utility}_{k} ) * {position\_disposition}_{j} & ( 14 ) \\ time\_utility {\_residual}_{ijk , j > \frac{l}{2}} = {accumulated\_CTR}_{1 \_ to \_k} * ( average\_time {\_utility}_{k} - {time\_utility}_{i = l * k} ) * {position\_disposition}_{j} & ( 15 ) \\ time\_utility {\_adjusted}_{ijk} = adjusted\_average \_time {\_utility}_{k} + time\_utility {\_residual}_{ijk} & ( 16 )\end{matrix}$$

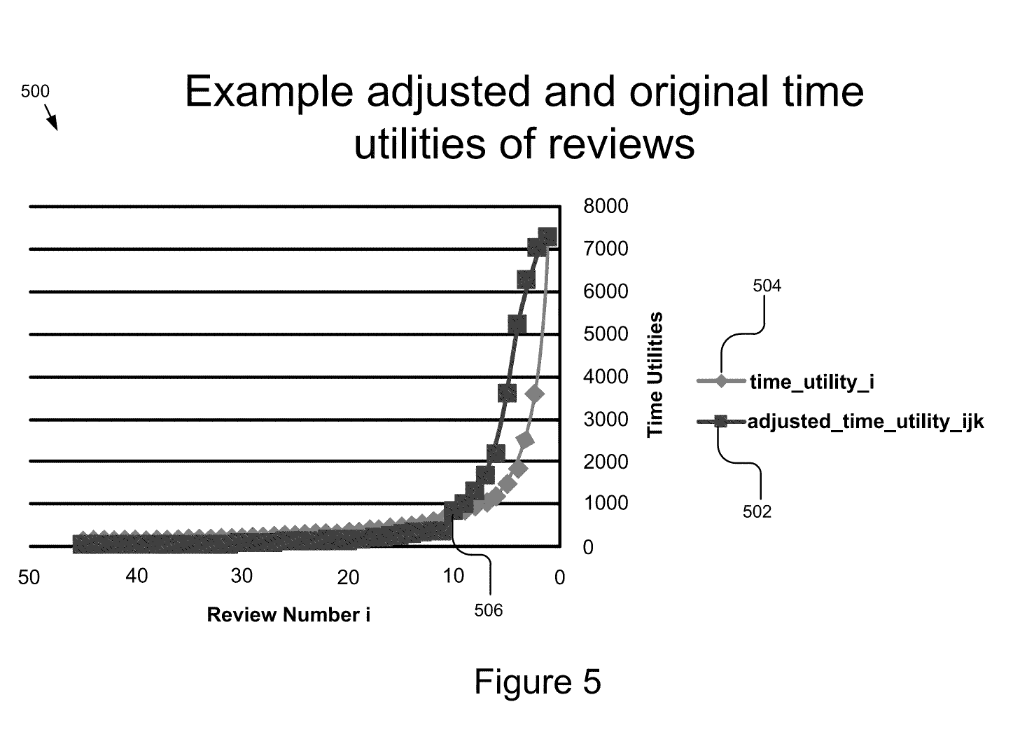

FIG. 5 is an illustration of a graph 500 showing an example relationship between time utility and adjusted time utility. For reference, the data in this graph 500 is based on the 1900 date system. As shown, the adjusted time utility 502 overweighs the original time utility 504 when the number of pages is small and when the differences in position is small (e.g., as indicated by the threshold point 506). In this example, there are m=5 pages, l=10 reviews per page, and a total of 45 reviews, assuming each review was submitted one day from now (Dec. 1, 2014 at 0 am) and the system began accepting review (Jan. 1, 1995 at 0 am, also called the time origin).

Additionally or alternatively to equations (2) or (5), the forecasting engine 126 may use the adjusted time utility to compute the weighted average of PPR as shown in equation (17) below. In some cases, the forecasting engine 126 may use more than one approach to compute the weighted average of PPR for a product (e.g., X) and then selectively determine which PPR value to use.

$$Weighted Average of PPR of SKU X = \frac{{\sum }_{i = 1}^{n} ( adjusted\_time {\_utility}_{i} * {PPR}_{i} )}{{\sum }_{i = 1}^{n} adjusted\_time {\_utility}_{i}} \qquad ( 17 )$$

Forecasting demand/popularity of a product.

When forecasting demand of a product, the forecasting engine 126 can consider the current stock level of the product (e.g., by inventory location, across inventory locations, etc.), PPRs, timing and page placement, past demand, seasonal demand, upcoming product releases, product versioning, and other variables, etc.

FIG. 8 is a flowchart illustrating an example method 800 for determining a product demand and/or a stock level (e.g., a stock quantity at a given time) for a product based on the PPRs of the reviews for that product.

As noted above, the model discussed below is a standard time series model with deterministic component and autoregressive errors, although it should be understood that other suitable models may be used in addition or the alternative. In the general form, the model may be represented as:

yₜ=E(yₜ)+Rₜ (18)

In equation (18) yₜ is the number of the particular product sold at time t, E(yₜ) is the deterministic component, and Rₜ is the autoregressive error.

In this example, timestamps may obtained/formatted using system time, such as POSIX time, 1900 system time, or another suitable system time. The time is then parsed by day. That is, t₀=the first day a product is available for sell, t₁=the second day a product is available for sale, etc.

At 802, the forecasting engine 126 computes a deterministic component based on one or more attributes. The deterministic component E(yₜ) may take the following general form:

E(yₜ)=Σ₀^{k}βᵢxᵢ (19)

In this example, for consistency with the notation system in time series models, the iterator i iterates from 0 to k which is the number of features (independent variable x′s) in the equation, which differs from the notation discussed above. In equation 19, βᵢ may include a trained parameter and xᵢ may include a dependent variable.

In e-commerce, information is often instantly available. As such, for ease of understanding, the variables used in the model algorithms discussed herein are not time-lagged, although it should be understood that time-lagged variables may be used for situations where the information is not instantly available. For instance, xᵢ (which corresponds to yₜ) will be taken from time t (xᵢ=x_{i,t}), although in in practice the independent variable may be time lagged. For example xᵢ can be treated as time lagged, from a days before (e.g., xᵢ=x_{i,t-a}). By way of further illustration, if a review generated today can only be viewed by customers tomorrow, a is equal to 1.

The xᵢ may include various independent variables, such as time attributes, review attributes, predicted probability to buy attributes, web related attributes, stocking related attributes, product attributes, technology attributes of an internet device, geospatial information of past purchases of the product, etc. For example, these attributes are described below.

Decomposition of time attributes.
Yearly trend: time stamp of t is transformed to corresponding year. For example, time stamp of 41973 in 1900 date system corresponds to year 2014.
Cyclical effect: time stamp of t is transformed to corresponding month. For example, time stamp of 41973 in 1900 date system is corresponding to the month of December. The cyclical effect may be computed using the following equations.

$$\begin{matrix}{x}_{i} = cos ( \frac{2 π}{12} month ) & ( 20 ) \\ {x}_{i + 1} = sin ( \frac{2 π}{12} month ) & ( 21 )\end{matrix}$$

Together with the coefficients, the cyclical effect's deterministic component may be computed by:

$${β}_{i} cos ( \frac{2 π}{12} month ) + {β}_{i + 1} sin ( \frac{2 π}{12} month ) \qquad ( 22 )$$

Weekly effect: time stamp of t is transformed to corresponding day of week. For example, time stamp of 41973 in 1900 date system is corresponding to Monday.

The weekly effect's deterministic component is (similar to cyclical effect).

$${β}_{i} cos ( \frac{2 π}{7} day\_of \_week ) + {β}_{i + 1} sin ( \frac{2 π}{7} day\_of \_week ) \qquad ( 23 )$$

The above equations for weekly and cyclical effect account for phase shift and assume equal amplitude from min to max and max to min as well as equal length of cycle between max to min and min to max. However, the above effects may have other assumptions, such as an unequal length of cycle between max to min and min to max.

As a further example, the peak month of the max demand of a product may be January and the min demand, which may regularly occur in July may occur in April.

The forecasting engine 126 may use the following function to model the deterministic component of cyclic effect:

$${β}_{i} cos ( f ( \frac{2 π}{12} month ) ) + {β}_{i + 1} sin ( f ( \frac{2 π}{12} month ) ) \qquad ( 24 )$$

The weekly effect could be modeled in a similar way.

Review attributes.
Adjusted (equation 17) or non-adjusted (equation 2) weighted average of PPRₜ at time t.
   As stated above, if in practice this information is time lagged, the forecasting engine 126 may select an appropriate value for a so that the corresponding PPR may be selected (PPRₜ₋ₐ at time t-a for yₜ). In addition, at time t, the weighted average of PPRₜ may in some embodiments utilize all available reviews at and before time t, instead of only at time t.
Total number of reviews at time t.
Average star rating of product at time t (which uses all available star ratings from time 0 to time t).
Tag attributes at time t.
   Total number of tags.
   Total number of positive tags (e.g., smooth printing).
   Total number of negative tags (e.g., jams paper).
   Etc.

Predicted probability to buy attributes.
Number of predicted probability to buy computed at time t. This is equivalent to perfect offer (e.g., an offer based on the predicted purchase probability of a product) being called for this product.
Average predicted probability to buy at time t.

Web related attributes.
Search term frequency of that product.
Search term narrowing frequency.
   E.g., the product is an apple iPad air and users search for this product by inputting “tablet” 200 times at time t₁, and narrow the search by brand by inputting “apple” 100 times at time t₂. In this example, the 100 times is search term narrowing frequency. Variations in computing the search term narrowing frequency are also possible.
Total time being viewed.
Total number of instances of this product being added to a list (etc., favorite, wish, todo).
Search term sorting frequency index.
   E.g., the product is an apple iPad air and the user selects to sort the results alphabetically (e.g., by a-z) on the search results page after searching for the keyword “tablet”.

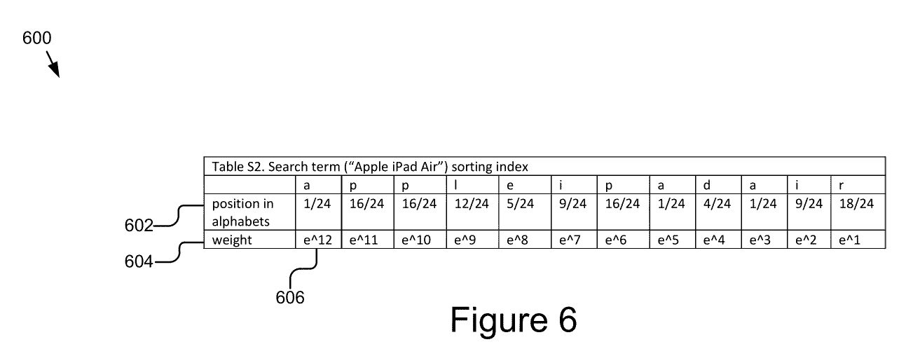

FIG. 6 is a table 600 including example positions and weights for an example search term. The table 600 includes example positions in row 602 and weights in row 604. As shown in FIG. 6, in above example the product name has 12 characters (e.g., Apple iPad Air), as indicated by the value of the weights in row 604. The first character, a, is listed at position 1 of 24 (1/24) of the alphabet and has a weight corresponding to a value ê12 at column 606.

The forecasting engine 126 can compute the weighted average of the alphabet position of each character in the product name using the following equation.

$$weighted average position = \frac{{\sum }_{1}^{12} position\_i * weight\_i}{{\sum }_{1}^{12} weight\_i} \qquad ( 25 )$$

In the above equation, the exponential in weight is to stress the non-linear importance of the first few characters.

Using the weighted average position, the forecasting engine 126 can then compute a value for the search term sorting frequency index using the following example equation.

$$search\_term \_sorting \_frequency \_index = ( 1 - weighted\_average \_position ) * number\_of \_times \_sorted \_a - z + weighted\_average \_position * number\_of \_times \_sorted \_z - a \qquad ( 26 )$$

Stocking related attributes.
The total number of days out of stock by time t.
The frequency per month out of stock by time t.
The total number of days out of stock in the previous month, etc.
The number of that item in stock.
Average volume of purchase order from vendor/merchants.
Average volume different types of customers buy.

In some embodiments, assuming a constant stocking rate, the forecasting engine 126 may estimate the popularity of the product based on how often it is out of stock (e.g., the more it is out of stock, the more popular it is).

Product attributes.
timestamp_nowᵢ, which reflects the release date of the product SKU X.
# of products in the same category (by way of reference, the smallest level of category is referred to as a class).
A binary indicator of whether the product is the most updated version of this series of products.
A binary indicator of whether the product is the original version of this series of products.

Technology attributes of the internet device.

The forecasting engine 126 may estimate the demographic of our customers based on the internet devices (e.g., user devices 112) they use to access/view the product page of a product X. In some embodiments, the forecasting engine 126 may compute statistics from the distribution of the internet device attributes. Non-limiting example attributes include the average internet speed of customers who viewed the product page of product X; the number of customers using different devices with different speed of access to the internet to access the product page; the number of different devices (tablet vs. desktop) accessing the internet; the different types internet connection used to access the product page; the different types and/or versions of software browsers (internet browsers; native apps; etc.) used to access the product page; etc.

Geospatial information of past purchases of product X.
The amount of purchases that have occurred by time t in each zip code.
Demographics (e.g., average income, average age, male population, female population, etc.) of the zip codes where past purchases happened by time t.

Returning to FIG. 8, at 804, the forecasting engine 126 may determine an autoregressive error. In the equation (18), Rₜ may be represented as:

Rₜ=Σⱼ₌₁^{j=p}ΦⱼRₜ₋ₚ+εₜ (27)

In the above equation, εₜ is the white noise, p is the order, R is the auto-regressive order, Φⱼ is the auto-regressive constant multiple factor between −1 to 1. Φⱼ can be tuned to minimize errors.

At 806, the forecasting engine 126 may determine a product demand based on the deterministic component and the autoregressive error, as discussed above (e.g., based on equation (18)).

At 808, the forecasting engine 126 may determine a stock level based on the product demand (e.g., at a time, as described above) and stocking related attributes. For example, turning now to out-of-stock forecasting, in some embodiments, the forecasting engine 126 may use the following equation to forecast whether a product is out of stock at a future time t.

$$\# \_of \_product X\_needed \_but \_not \_in \_stock \_at \_time \_t = \# \_of \_product X\_in \_stock \_at \_time \_t - {\sum }_{now}^{t} predicted\_demand \_of \_product \_each \_day \qquad ( 28 )$$

In the above equation, the predicted demand of product at time stamp between now and t may be computed using equation (18), which is a time series autoregressive model for forecasting. In some cases, if a feature for a future day is not available, e.g., there may not be any reviews available for that future day, the forecasting engine 126 may use the feature's value of now instead. Stock of a product SKU X at time t is a deterministic number, assuming the current stocking number for the product is accurate and that there is an accurate plan of purchasing from merchants for product SKU X between time now and time t. In some embodiments, the forecasting engine 126 may compute stock of the product SKU X at time t using the following equation.

#_of_product_X_in_stock_at_time_t=#_of_product_X_in stock_now+each_#_of_planned_purchase_of _product_X_between_now_and_{—t} (29)

In some cases, if the future plans for purchasing from a merchant is not available, the forecasting engine 126 can utilize a separate model to model the purchasing fluency and quantity.

While attributes that are unique to product X for the prediction of demand forecasting are largely discussed in this document, the forecasting engine 126 can use commonly shared attributes for demand forecasting in addition and/or in the alternative to the unique attributes.

In some embodiments, for a new product (e.g., just released, etc.) where insufficient product attributes are stored in the data store 208, the forecasting engine 126 can use the product attributes from a similar product, such as a similar product from the same brand and the same class (e.g., until sufficient product attributes for that product are available).

It should be understood that the methods 300, 700, 800, etc., are provided by way of example, and the variations and combinations of these methods, as well as other methods, are contemplated. For example, in some embodiments, at least a portion of the methods 300, 700, 800, etc. represent various segments of one or more larger methods and may be concatenated or various steps of these methods may be combined to produce other methods which are encompassed by the present disclosure. Additionally, it should be understood that the semantic analysis and probability determination as described with reference to at least the methods 300, 700, 800, etc. are often iterative, and thus repeated as many times as necessary to process each review, product, etc., a group of reviews, products, etc., products associated with a plurality of users and/or a timeframe, etc.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various embodiments are described as having particular hardware, software, and user interfaces. However, the present disclosure applies to any type of computing device that can receive data and commands, and to any peripheral devices providing services.

In some instances, various embodiments may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the computing environment 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take various forms including embodiments having software and/or hardware elements. For instance, the technology may be implemented in software, which includes but is not limited to firmware, resident software, microcode, a client-server application, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to embodiment in any specific programming language, or for any specific operating system or environment.

What is claimed is:

1. A computer-implemented method for review sentiment analysis and probability prediction using an artificial neural network comprising:
receiving a product review for a product, the product review having product review text;
determining attributes of the product review text, the attributes including one or more of a word, an emoticon, and punctuation;
feeding the attributes of the product review text into a first layer of an artificial neural network based on an attribute type, the first layer of the neural network having a first output;
feeding the first output of the first layer of the neural network into a second layer of the artificial neural network based on an association of the attributes of the product review text with one or more of a story, a function, and a sentiment, the second layer having a second output; and
determining a predicted probability of recommendation of the review based on the second output of the second layer.

2. The computer-implemented method of claim 1, further comprising feeding the predicted probability of recommendation into a time series model to predict a product demand for the product.

3. The computer-implemented method of claim 2, wherein predicting the product demand for the product includes determining a time diminished utility for the product review.

4. The computer-implemented method of claim 2, further comprising forecasting a stock level for the product based on the product demand for the product.

5. A computer-implemented method comprising:
receiving one or more product reviews for a product, the one or more product reviews having product review text;
semantically analyzing the product review text using a first computer model to determine a predicted probability of recommendation for each of the one or more product reviews;
selecting a particular product review of the one or more product reviews based on the predicted probability of recommendation of the particular product review; and
providing the particular product review for display on a user device.

6. The computer-implemented method of claim 5, wherein semantically analyzing the product review text includes
determining attributes of the product review text,
feeding the attributes of the product review text into a first layer of a neural network based on an attribute type, the first layer of the neural network having an output, and
feeding the output of the first layer of the neural network into a second layer of a neural network based on an association of the attributes of the product review with one or more of a story, a function, and a sentiment.

7. The computer-implemented method of claim 5, wherein semantically analyzing the product review text includes parsing emoticons from the product review text and inputting the emoticons into the first computer model.

8. The computer-implemented method of claim 7, wherein the emoticons are interpreted by the first computer model as an indication of sentiment in the one or more product reviews and an indication of punctuation in the one or more product reviews.

9. The computer-implemented method of claim 5, further comprising feeding the predicted probability of recommendation into a second computer model to determine a purchase probability of the product.

10. The computer-implemented method of claim 9, further comprising:
determining a time diminished average predicted probability of recommendation for the product based on the predicted probability of recommendation and a timestamp for each of the one or more product reviews; and
feeding the time diminished average predicted probability of recommendation into the second computer model to determine the purchase probability for the product.

11. The computer-implemented method of claim 9, wherein the first computer model is an artificial neural network and the second computer model is a gradient boosted machine.

12. The computer-implemented method of claim 9, further comprising forecasting product demand based on the purchase probability of the product.

13. The computer-implemented method of claim 9, further comprising predicting a stock level for the product based on the purchase probability of the product and a stock quantity of the product.

14. A system comprising:
one or more processors; and
a non-transitory computer readable memory storing instructions that, when executed by the one or more processors cause the system to perform operations including:
receiving one or more product reviews for a product, the one or more product reviews having product review text;
semantically analyzing the product review text using a first computer model to determine a predicted probability of recommendation for each of the one or more product reviews;
selecting a particular product review of the one or more product reviews based on the predicted probability of recommendation of the particular product review; and
providing the particular product review for display on a user device.

15. The system of claim 14, wherein semantically analyzing the product review text includes
determining attributes of the product review text,
feeding the attributes of the product review text into a first layer of a neural network based on an attribute type, the first layer of the neural network having an output, and
feeding the output of the first layer of the neural network into a second layer of a neural network based on an association of the attributes of the product review with one or more of a story, a function, and a sentiment.

16. The system of claim 14, wherein semantically analyzing the product review text includes parsing emoticons from the product review text and inputting the emoticons into the first computer model.

17. The system of claim 16, wherein the emoticons are interpreted by the first computer model as an indication of sentiment in the one or more product reviews and an indication of punctuation in the one or more product reviews.

18. The system of claim 14, wherein the operations further comprise feeding the predicted probability of recommendation into a second computer model to determine a purchase probability of the product.

19. The system of claim 18, wherein the operations further comprise
determining a time diminished average predicted probability of recommendation for the product based on the predicted probability of recommendation and a timestamp for each of the one or more product reviews, and
feeding the time diminished average predicted probability of recommendation into the second computer model to determine the purchase probability for the product.

20. The system of claim 18, wherein the first computer model is an artificial neural network and the second computer model is a gradient boosted machine.

21. The system of claim 18, wherein the operations further comprise forecasting product demand based on the purchase probability of the product.

22. The system of claim 18, wherein the operations further comprise predicting a stock level for the product based on the purchase probability of the product and a stock quantity of the product.
